(19) United States
(12) Patent Application Publication
(10) Pub. No.: US 2009/0153119 A1
(43) Pub. Date: Jun. 18, 2009

(54) METHOD AND DEVICE FOR MEASURING CURRENT FOR A DC-DC CONVERTER

(75) Inventors: Severin TROCHUT, Gilly-Sur-Isere (FR); David CHESNEAU, La Buisse (FR)

Correspondence Address: GRAYBEAL JACKSON LLP, 155 - 108TH AVENUE NE, SUITE 350, BELLEVUE, WA, 98004-5973, US

(73) Assignee: STMICROELECTRONICS SA, Montrouge (FR)

(21) Appl. No.: 12/336,516

(22) Filed: Dec. 16, 2008

(30) Foreign Application Priority Data
Dec. 17, 2007 (FR) 07 59910

(51) Int. Cl. G05F 1/00

(52) U.S. Cl. 323/282

(57) ABSTRACT

An embodiment of a current sensing device for a DC-DC converter comprising an output node through which passes an output current and taken to an output potential equal respectively to first and second values. The current sensing device comprises an amplifying module comprising a retroaction node through which passes a mirror current that is proportional to the output current and taken to the potential present on a first input of the amplifying module. The device also comprises a first intermediate module mounted between the first potential and the output node, comprising an intermediate node connected to the first input and taken to an intermediate potential equal to third and fourth values respectively correlated to the first and second values, wherein the difference between the third and fourth values is smaller than the difference between the first and second values.

### RELATED APPLICATION DATA

The present application is related to commonly assigned U.S. patent application Ser. No. ______ (Attorney Docket No. 2269-097-03), entitled CURRENT MEASURING DEVICE, which application has the same filing date as the present application and is incorporated herein by reference in its entirety.

### PRIORITY CLAIM

The present application claims the benefit of French Patent Application Serial No. 0759910, filed Dec. 17, 2007, which application is incorporated herein by reference in its entirety.

### TECHNICAL FIELD

An embodiment of the present invention relates generally to the regulation of voltage in a DC-DC type voltage converter, and more especially to a current sensing device for a DC-DC converter.

### BACKGROUND

In general, a DC-DC converter converts an available DC voltage, for example supplied by a battery, into a predetermined and regulated DC voltage, required to power a load, wherein the regulated DC voltage may be greater than or lower than the voltage source.

For example, the DC-DC switching converter shown in FIG. 1, wherein only the elements required for it to be understood have been shown, comprises a first POWER_MOS_1 switching device and a second POWER_MOS_2 switching device in series between a first potential VBAT, for example a DC power source, and a second potential GND, for example the ground. The first and second switching devices POWER_MOS_1, POWER_MOS_2, are connected to one another by an output node 10, and form a connection module 1. The first switching device POWER_MOS_1 is mounted between the first potential VBAT and the output node 10, and the second switching device POWER_MOS_2 is mounted between the output node 10 and the second potential GND. The output node 10 has passing through it an output current IL to an output potential VLX. The DC-DC converter further comprises an inductive element L in series with a capacitive element C coupled to a load LOAD between the output node 10 and the second potential GND.

The first and second switching devices POWER_MOS_1, POWER_MOS_2, are for example power transistors of the MOS (Metal Oxide Semiconductor) type respectively with a P channel and N channel, of low residual resistance (resistance of the transistors in the conductive state).

Consequently, by connecting alternately the inductive element L to the first potential VBAT and to the second potential GND, and thus by switching the flow of the output current from the inductive element L, the DC-DC converter supplies, to the VOUT connection node between the inductive element L, the capacitor C and the load LOAD, a regulated output voltage.

In function of the information available on the current and/or voltage at the output node 10, a control circuit, known to a person skilled in the art and not shown here, supplies and sends a control signal to the transistor gates to modulate the conduction times of these transistors. The control circuit adjusts a duty cycle of the control signal for each of the first and second switching devices POWER_MOS_1, POWER_MOS_2, in order to maintain the value of the output voltage constant. The control signal may be for example of the pulse-width-modulation (PWM) type.

In a DC-DC converter, to regulate the output voltage of the converter, there are two types of regulation:

voltage regulation, also called voltage mode control, and
current regulation, also called current mode control.

In general, voltage regulation may be preferred as it is easier to implement. However, current regulation may provide better performance.

In current regulation, the knowledge of the current passing through the inductive element L is important. The difficulty lies in the implementation of a good current measuring device, or current sensing device, which needs to be rapid and precise. Whereas at present, there are no satisfactory solutions which permit a current sensing device to be easily implemented that combines speed and precision.

One example of a current sensing device of the prior art is illustrated in FIG. 1. This current sensing device uses the current mirror technique. Its principle is to copy the output potential VLX present at the output node 10 using a traditional amplifier AMP, to obtain a current that is proportional to the output current IL, and consequently carrying information on the output current IL. This current information is then used for example by the control circuit to generate the regulation control signal.

This current sensing device comprises an amplifying module 2 comprising third and fourth switching devices SENSE_MOS_1, SENSE_MOS_2 connected to one another by a retro-action node 20, and mounted between the first potential VBAT and for example a control circuit input. The third switching device SENSE_MOS_1 is mounted between the first potential VBAT and the retroaction node 20, and the fourth switching device SENSE_MOS_2 is mounted between the retroaction node 20 and the control circuit input. The current sensing device also comprises an amplifier AMP of which a first input (or non-inverting input) is, for example, connected to the output node 10, and a negative input (or inverting input) connected to the retroaction node 20. The third and fourth switching devices SENSE_MOS_1, SENSE_MOS_2 are for example MOS type transistors with a channel P of low power with respect to the first and second switching devices POWER_MOS_1, POWER_MOS_2, and are respectively controlled by the control signal and a signal generated at the output of the amplifier AMP.

In this configuration, the third switching device SENSE_MOS_1 and the first switching device POWER_MOS_1 have the same behavior, and the amplifier AMP takes the retroaction node 20 to a third potential that is equal to the potential present at the positive input, which is to say the output potential VLX.

In these conditions, the amplifying module 2 generates a mirror current IL′ at the retroaction node 20 related to the output current IL by a coefficient of proportionality equal to a size ratio. For example, if the first switching device POWER_MOS_1 and the third switching device SENSE_MOS_1 have a size ratio RATIO1:1, the mirror current IL′=IL/RATIO1, wherein the first ratio RATIO1 is for example equal to 10000.

The mirror current IL′ is then sent to the input of the control circuit via the fourth switching device SENSE_MOS_2.

A potential disadvantage of this solution of the prior art is that due to the ratio (which may be too high) between the switching devices of the connection module and of the amplifying module, adaptation (or matching) during manufacture may be difficult or poor.

In function of the control signal received, the connection module 1 may adopt a first or a second state. The first state places the first switching device POWER_MOS_1 in conduction and the second switching device POWER_MOS_2 in non-conduction, thus permitting the output node 10 to be connected to the first potential VBAT. The second state places the first switching device POWER_MOS_1 in non-conduction and the second switching device POWER_MOS_2 in conduction, thus permitting the output node 10 to be connected to the second potential GND.

When the connection module 1 is in the first state, the first potential VBAT is solicited, and the output potential VLX is then equal to a first value. This first value is equal, in this case, to the difference between the first potential VBAT and the product between the output current IL and the residual resistance, reference RDSON_PM1, of the first switching device POWER_MOS_1, i.e. VLX=VBAT−IL*RDSON_PM1, and by approximation VLX=VBAT. This output potential VLX is then sent to the positive input of the amplifier.

The amplifier AMP thus receives at its positive input a potential level that is close to the first potential VBAT.

As the third switching device SENSE_MOS_1 receives the same control signal as the first switching device POWER_MOS_1, when the connection module is in the first state, the third switching device SENSE_MOS_1 is placed in conduction and the potential present at the retroaction node 20 is equal to the output potential VLX.

When the connection module 1 is in the second state, the output potential VLX is then equal to a second value. This second value is equal, in this case, to the second potential GND less the product of the output current IL and the residual resistance, reference RDSON_PM2, of the second switching device POWER_MOS_2, i.e. VLX=GND−IL*RDSON_PM2, and by approximation VLX=GND. This output potential VLX is then sent to the positive input of the amplifier.

The amplifier AMP thus receives at its positive input a potential level that is close to the second potential GND.

Consequently, in this solution of the prior art, the output potential VLX, sent to the positive input of the amplifier AMP, varies in general between the first potential VBAT and the second potential GND. As there is a considerable difference between the first and second values of the output potential, another potential disadvantage is that the amplifier AMP suffers a lot of stresses, which may reduce the rapidity and precision of the current sensing device.

### SUMMARY

Therefore, an embodiment of the present invention is to propose a current sensing device for DC-DC type converters that does not have at least one of the above limitations.

An embodiment of the invention limits the excursion of the potential present at the positive input of the amplifier, and more precisely limits the excursion of the node viewed by the amplifier, and includes a current sensing device for DC-DC type converters that is more efficient and rapid.

These purposes, as well as others, may be achieved by an embodiment the invention, a current sensing device for DC-DC type converters comprising at least one connection module mounted between first and second potentials, and comprising at least one output node taken to an output potential and through which an output current flows, wherein the connection module is able to connect alternately the output node to the first and the second potential, fixing the output potential respectively to a first and a second value, wherein the current sensing device has at least one amplifying module comprising at least one retro-action node and a first and a second input, wherein the retro-action node has passing through it a mirror current that is proportional to the output current and is taken to a third potential that is equal to the potential present on the first input of the amplifying module, and wherein the second input is connected to the first potential.

According to an embodiment of the invention, the current sensing device further comprises an intermediate module mounted between the first potential and the output node, comprising at least one intermediate node at least connected to the first potential, connected to the first input of the amplifying module and taken to an intermediate potential, wherein this intermediate potential is equal to a third and a fourth value that are respectively correlated to the first and second values, wherein the difference between the third and fourth values is smaller than the difference between the first and second values.

An embodiment of the connection module comprises at least first and second switching devices connected to one another by the output node, and mounted in series between the first and second potentials, wherein the first and second switching devices are controlled by a control signal.

An embodiment of the amplifying module comprises at least:

third and fourth switching devices connected to one another by a retroaction node, wherein the third switching device is controlled by the control signal and is mounted between the first potential and the retroaction node, and
an amplifier controlling the fourth switching device and comprising a positive input connected to the first input, and a negative input connected to the retroaction node.

An embodiment of the intermediate module comprises a least:

a fifth switching device in conduction and mounted between the first potential and the intermediate node, and
a sixth switching device mounted between the intermediate node and the output node, and controlled by the control signal.

Another embodiment of the invention is a current sensing method for a DC-DC type converter comprising at least one connection module mounted between first and second potentials, wherein the connection module comprises at least one output node taken to an output potential and through which an output current passes, wherein the connection module is able to connect the output node to a first and a second potential, fixing the output potential respectively to a first and a second value, wherein the connection module comprises at least the stages comprising:

connecting an intermediate node of an intermediate module to the first potential,
connecting the intermediate node to the output node if the output node is connected to the first potential, or disconnecting the intermediate node from the output node if the output node is connected to the second potential,
generating, at the intermediate node, an intermediate potential equal to a third or a fourth value, respectively correlated to the first or second value, wherein the difference between the third and the fourth value is smaller than the difference between the first and second values,
sending the intermediate potential to a first input of an amplifying module,
connecting a retroaction node from the amplifying module to the first potential if the output node is connected to the first potential, disconnecting the retroaction node from the first potential if the output node is connected to the second potential,
taking the retroaction node to a third potential present on the first input, and
generating, at the retroaction node, a mirror current proportional to the output signal.

The output node may be connected to the first potential via a first switching device and may be connected to the second potential via a second switching device, wherein the first and second switching devices may be controlled by a control signal that is a function of at least the mirror current.

The retroaction node may be connected to the first potential via a third switching device controlled by the control signal.

The retroaction node may be taken to the third potential by an amplifier which receives on a positive input the intermediate potential and on a negative input the third potential.

The mirror current may pass through, for example, a fourth switching device controlled by the amplifier and connected to a retroaction node.

The intermediate node may be connected to the first potential via a fifth switching device and may be connected to the output node via a sixth switching device controlled by the control signal

Another embodiment of the invention is a voltage converter comprising at least the device described above.

More precisely, an embodiment of the invention relates to a current sensing device for a DC-DC converter comprising at least one connection module mounted between first and second potentials, and comprising at least one output node taken to an output potential and through which an output current flows, wherein the connection module is able to connect alternately the output node to the first and the second potential, fixing the output potential respectively to a first and a second value, wherein the current sensing device has at least one amplifying module comprising at least one retro-action node and a first and a second input, wherein the retro-action node has passing through it a mirror current that is proportional to the output current and is taken to a third potential that is equal to the potential present on the first input of the amplifying module, and wherein the second input is connected to the first potential.

An embodiment of the invention applies to DC-DC boost converters, buck converters and buck-boost converters, of which the operating principle is known to a person skilled in the art.

### BRIEF DESCRIPTION OF THE DRAWINGS

Features and advantages of one or more embodiments of the present invention will be described in more detail in the following description, made in relation to the attached figures along which:

FIG. 1, previously described, presents a diagram of a current sensing device for a DC-DC converter;

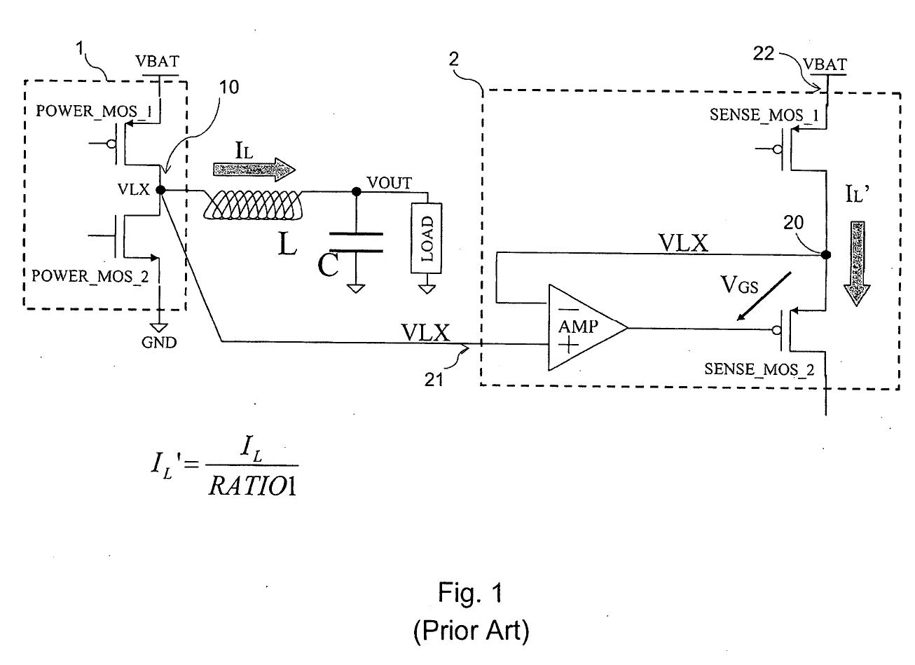

FIG. 2 presents in block diagram form a current-sensing device according to an embodiment of the invention coupled to a DC-DC converter; and

FIG. 3 presents in more detail the embodiment of FIG. 2.

### DETAILED DESCRIPTION

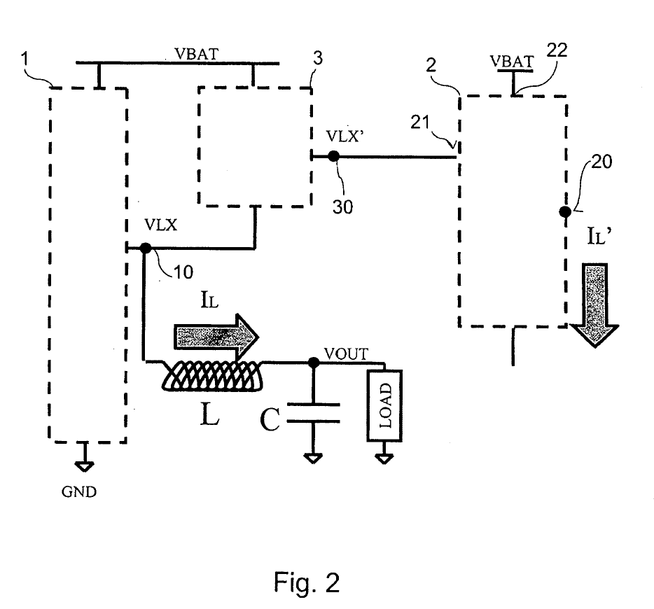

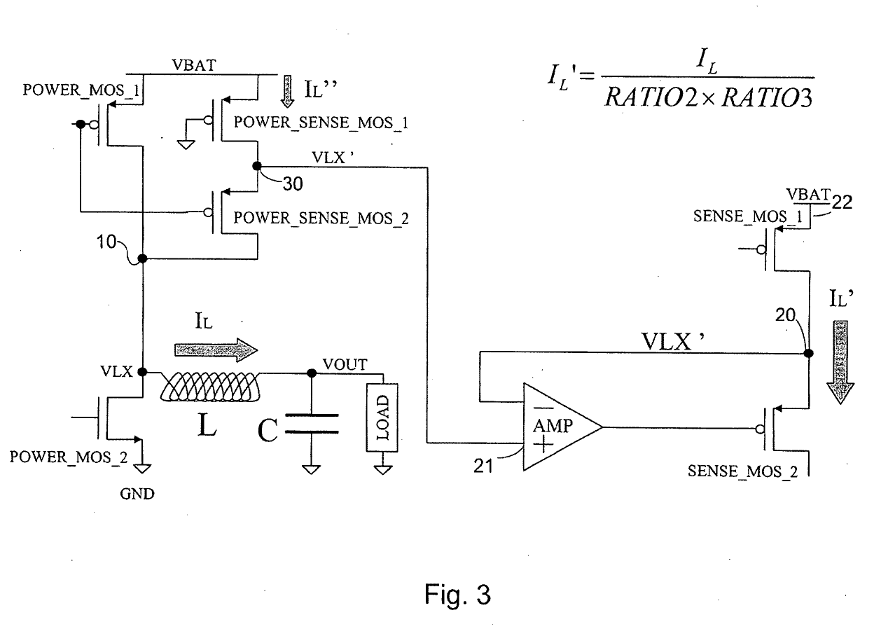

In FIG. 2 and FIG. 3, in addition to the elements of the connection module 1 and the amplifying module 2 already presented and described, there is also an intermediate module 3 comprising fifth and sixth switching devices POWER_SENSE_MOS_1, POWER_SENSE_MOS_2, connected to one another by an intermediate node 30, and mounted in series between the first potential VBAT and the output node 10. The fifth switching device POWER_SENSE_MOS_1 is connected between the first potential VBAT and the intermediate node and is always in conduction. The sixth switching device POWER_SENSE_MOS_2 is mounted between the intermediate node 30 and the output node 10, and is controlled by the same control signal sent to the first switching device POWER_MOS_1.

In this configuration, the behaviors of the fourth switching device POWER_SENSE_MOS_1 and the first switching device POWER_MOS_1 are similar.

However, contrary to the solution of the prior art, the positive input of the amplifier AMP is no longer connected directly to the output node 10, but to the intermediate node 30. The positive input of the amplifier AMP thus receives the potential present at the intermediate node 30, referenced intermediate potential VLX′.

Therefore, when the connection module is in the first state, the first switching device POWER _MOS_1 is placed in conduction, the output potential VLX is set to the first value, the fifth switching device POWER_SENSE_MOS_2 is also placed in conduction and the intermediate potential VLX′ is equal to a third value. In this configuration, the third value is equal to the difference between the first potential VBAT and the product of the current IL″ passing through the fifth switching device POWER_SENSE_MOS_1 by the residual resistance, noted RDSON_PSM1, of the fifth switching device POWER_SENSE_MOS_1, i.e. VLX′=VBAT−IL″*RDSON_PSM1. As the product IL″*RDSON_PSM1 is in general very low in comparison to VBAT, the third value may be approximated to VBAT. This intermediate potential VLX′ is the sent to the positive input of the amplifier AMP. The amplifier AMP takes the retroaction, e.g., feedback, node of the intermediate potential VLX′ and the amplifying module 2 generates the mirror current IL′ related to the output current IL by the coefficient of proportionality. For example, if there is a RATIO2:1 between the first switching device POWER_MOS_1 and the fifth switching device POWER_SENSE_MOS_1, and a size ration RATIO3:1 between the fifth switching device POWER_SENSE_MOS_1 and the third switching device SENSE_MOS_1, then IL′=IL/(RATIO2*RATIO3). For example, RATIO2=RATIO3=100.

When the connection module 1 is in the second state, the second switching device POWER_MOS_2 is placed in conduction, the output potential VLX is set to the second value, the fifth switching device POWER_SENSE_MOS_2 is placed in non-conduction and the intermediate potential VLX′ is equal to the first potential VBAT, i.e. VLX′=VBAT This intermediate potential VLX′ is the sent to the positive input of the amplifier AMP.

Therefore the intermediate potential VLX′ sent to the positive input of the amplifier AMP, that is representative of the VLX output potential when the connection module is in the first state, is almost stable as it varies in general near the first potential VBAT. The difference between the third and fourth values of the intermediate potential is indeed smaller than the difference between the first ad second values of the output potential VLX, wherein the excursion of the intermediate potential VLX′ is reduced with respect to that of the output potential VLX. The stresses suffered by the amplifier AMP are therefore greatly diminished.

The fourth and fifth switching devices POWER_SENSE_MOS_1, POWER_SENSE_MOS_2, are for example P channel type MOS transistors with lower-power capacity compared to the first and second switching devices POWER_MOS_1, POWER_MOS_2.

Furthermore, as the ratio between the switching devices of the connection module 1 and the intermediate module 3, and the ratio between the switching devices of the intermediate module 3 and the amplifying module 2 are smaller, the adaptation (or matching) during manufacture is easier.

Therefore, an embodiment permits the excursion of the node (here, the node 30) viewed by the amplifier 21 to be limited, and the requirements in terms of amplifier pass band may be lower with respect to the solutions of the prior art.

Still referring to FIG. 2 and FIG. 3, the DC-DC converter may be wholly or partially disposed on an integrated circuit and may be part of a system in which it provides a regulated voltage VOUT to another integrated circuit, such as a microprocessor. These integrated circuits may be disposed on the same integrated circuit die or on respective dies.

Furthermore, although the DC-DC converter of FIG. 2 and FIG. 3 is shown as being a single-phase converter (the inductive element L and stage 1 compose a phase); it may include multiple phases. In a multi-phase embodiment, each phase may include a respective stage 2 and a respective stage 3, or there may be common stages 2 and 3 for all or subgroups of the phases.

Although the stage 2 and transistor SENSE_MOS_2 are shown coupled to VBAT, they may be coupled to VOUT.

Moreover, the transistor POWER_MOS_1 may be N-channel instead of P-channel, with its gate connected to an inverted signal relative to the transistor POWER_MOS_2.

Naturally, in order to satisfy local and specific requirements, a person skilled in the art may apply to the solution described above many modifications and alterations. Particularly, although the present invention has been described with a certain degree of particularity with reference to described embodiment(s) thereof, it should be understood that various omissions, substitutions and changes in the form and details as well as other embodiments are possible. Moreover, it is expressly intended that specific elements and/or method steps described in connection with any disclosed embodiment of the invention may be incorporated in any other embodiment as a general matter of design choice.

1. A current-sensing device for a DC-DC type converter comprising at least one connection module mounted between first and second potentials, and comprising at least one output node taken to an output potential and through which an output current flows, wherein the connection module is able to connect alternately the output node to the first and the second potential, fixing the output potential respectively to a first and a second value,
wherein the current sensing device has at least one amplifying module comprising at least one retro-action node and a first and a second input, wherein the retro-action node has passing through it a mirror current that is proportional to the output current and is taken to a third potential that is equal to the potential present on the first input of the amplifying module, and wherein the second input is connected to the first potential, and
an intermediate module mounted between the first potential and the output node, comprising at least one intermediate node at least connected to the first potential, at least connected to the first input of the amplifying module and taken to an intermediate potential, wherein this intermediate potential is equal to a third and a fourth value that are respectively correlated to the first and second values, wherein the difference between the third and fourth values is smaller than the difference between the first and second values.

2. The device according to claim 1, wherein the connection module comprises at least first and second switching devices, connected to one another by the output node, and mounted in series between the first and second potentials, wherein the first and second switching devices are controlled by a control signal.

3. The device according to claim 1, wherein the amplifying module comprises at least:
third and fourth switching devices connected to one another by a retro-action node, wherein the third switching device is controlled by the control signal and is mounted between the first potential and the retroaction node, and
an amplifier controlling the fourth switching device and comprising a positive input connected to the first input and a negative input connected to the retroaction node.

4. The device according to claim 1, wherein the intermediate module comprises at least:
a fifth switching device in conduction and mounted between the first potential and the intermediate node, and
a sixth switching device mounted between the intermediate node and the output node, and controlled by the control signal.

5. A current sensing method for a DC-DC type converter comprising at least one connection module mounted between first and second potentials, wherein the connection module comprises at least one output node taken to an output potential and through which an output current passes, wherein the connection module is able to connect the output node to a first and a second potential, fixing the output potential respectively to a first and a second value,
comprising at least the steps consisting of:
connecting an intermediate node of an intermediate module to the first potential,
connecting the intermediate node to the output node if the output node is connected to the first potential, or disconnecting the intermediate node from the output node if the output node is connected to the second potential,
generating, at the intermediate node, an intermediate potential equal to a third or a fourth value, respectively correlated to the first or second value, wherein the difference between the third and the fourth value is smaller than the difference between the first and second values,
sending the intermediate potential to a first input of an amplifying module,
connecting a retroaction node from the amplifying module to the first potential if the output node is connected to the first potential, disconnecting the retroaction node from the first potential if the output node is connected to the second potential,
taking the retroaction node to a third potential equal to the potential present on the first input, and
generating, at the retroaction node, a mirror current proportional to the output signal.

6. The method according to claim 5, wherein the output node is connected to the first potential via a first switching device and is connected to the second potential via a second switching device, wherein the first and second switching devices are controlled by a control signal that is a function at least of the mirror current.

7. The method according to claim 5, wherein the retroaction node is connected to the first potential via a third switching device controlled by the control signal.

8. The method according to claim 5, wherein the retroaction node is taken to the third potential by an amplifier which receives on a positive input the intermediate potential and on a negative input the third potential.

9. The method according to claim 5, wherein the mirror current passes through a fourth switching device controlled by the amplifier connected to the retroaction node.

10. The method according to claim 5, wherein the intermediate node is connected to the first potential via a fifth switching device and is connected to the output node via a sixth switching device controlled by the control signal.

11. A power supply controller, comprising:
a first stage operable to receive a switching voltage from a switching stage and to generate a first feedback signal in response to the switching voltage; and
a second stage coupled to the first stage and operable to generate a second feedback signal in response to the first feedback signal.

12. The power supply controller of claim 11, further comprising:
a first supply node operable to be coupled to an input voltage of the power supply;
a second supply node operable to be coupled to a reference voltage of the power supply; and
wherein the first stage comprises
a first switch having a first conduction node coupled to the first supply node, a second conduction node, and a control node coupled to the second supply node, and
a second switch having a first conduction node coupled to the second conduction node of the first switch and to the second stage, a second conduction node operable to be coupled to an output node of the switching stage, and a control node operable to be coupled to an input node of the switching stage.

13. The power supply controller of claim 11, further comprising:
a first supply node operable to be coupled to an input voltage of the power supply;
a second supply node operable to be coupled to a reference voltage of the power supply; and
wherein the first stage comprises
a first transistor having a first conduction node coupled to the first supply node, a second conduction node, and a control node coupled to the second supply node, and
a second transistor having a first conduction node coupled to the second conduction node of the first transistor and to the second stage, a second conduction node operable to be coupled to an output node of the switching stage, and a control node operable to be coupled to an input node of the switching stage.

14. The power supply controller of claim 11, further comprising:
a first supply node operable to be coupled to an input voltage of the power supply;
a second supply node operable to be coupled to a reference voltage of the power supply; and
wherein the first stage comprises
a first P channel transistor having a first source drain coupled to the first supply node, a second source drain, and a gate coupled to the second supply node, and
a second P channel transistor having a first source drain coupled to the second source drain node of the first transistor and to the second stage, a second source drain node operable to be coupled to an output node of the switching stage, and a gate operable to be coupled to an input node of the switching stage.

15. The power supply controller of claim 11, further comprising:
a first supply node operable to be coupled to an input voltage of the power supply; and
wherein the second stage comprises
a first switch having a first conduction node coupled to the first supply node, a second conduction node, and a control node operable to be coupled to the switching stage of the power supply,
a second switch having a first conduction node coupled to the second conduction node of the first switch, a second conduction node operable to provide the second feedback signal, and a control node, and
a differential amplifier having a first input node coupled to the first stage, a second input coupled to the second conduction node of the first switch, and having an output node coupled to the control node of the second switch.

16. The power supply controller of claim 11, further comprising:
a first supply node operable to be coupled to an input voltage of the power supply; and
wherein the second stage comprises
a first transistor having a first conduction node coupled to the first supply node, a second conduction node, and a control node operable to be coupled to the switching stage of the power supply,
a second transistor having a first conduction node coupled to the second conduction node of the first transistor, a second conduction node operable to provide the second feedback signal, and a control node, and
a differential amplifier having a first input node coupled to the first stage, a second input coupled to the second conduction node of the first transistor, and having an output node coupled to the control node of the second transistor.

17. The power supply controller of claim 11, further comprising:
a first supply node operable to be coupled to an input voltage of the power supply; and
wherein the second stage comprises
a first P channel transistor having a first source drain coupled to the first supply node, a second source drain, and a gate operable to be coupled to the switching stage of the power supply,
a second P channel transistor having a first source drain coupled to the second source drain of the first transistor, a second source drain operable to provide a feedback current as the second feedback signal, and a gate, and
a differential amplifier having a non inverting node coupled to the first stage, an inverting input coupled to the second source drain of the first transistor, and having an output node coupled to the gate of the second transistor.

18. The power supply controller of claim 11, further comprising:
a first supply node operable to be coupled to an input voltage of the power supply;
a second supply node operable to be coupled to a reference voltage of the power supply;
wherein the first stage comprises
a first transistor having a first conduction node coupled to the first supply node, a second conduction node, and a control node coupled to the second supply node, and
a second transistor having a first conduction node coupled to the second conduction node of the first transistor and to the second stage, a second conduction node operable to be coupled to an output node of the switching stage, and a control node operable to be coupled to an input node of the switching stage; and
wherein the second stage comprises
a third transistor having a first conduction node coupled to the first supply node, a second conduction node, and a control node coupled to the control node of the second transistor,
a fourth transistor having a first conduction node coupled to the second conduction node of the first transistor, a second conduction node operable to provide the second feedback signal, and a control node, and
a differential amplifier having a first input node coupled to the second conduction node of the first transistor, a second input node coupled to the second conduction node of the third transistor, and an output node coupled to the control node of the fourth transistor.

19. The power supply controller of claim 11, further comprising:
a first supply node operable to be coupled to an input voltage of the power supply;
a second supply node operable to be coupled to a reference voltage of the power supply;
wherein the first stage comprises
a first transistor having a first conduction node coupled to the first supply node, a second conduction node, and a control node coupled to the second supply node, and
a second transistor having a first conduction node coupled to the second conduction node of the first transistor and to the second stage, a second conduction node operable to be coupled to an output node of the switching stage, a control node operable to be coupled to an input node of the switching stage, and a channel dimension; and
wherein the second stage comprises
a third transistor having a first conduction node coupled to the first supply node, a second conduction node, and a control node coupled to the control node of the second transistor,
a fourth transistor having a first conduction node coupled to the second conduction node of the first transistor, a second conduction node operable to provide the second feedback signal, a control node, and a channel dimension that is smaller than the channel dimension of the second transistor, and
a differential amplifier having a first input node coupled to the second conduction node of the first transistor, a second input node coupled to the second conduction node of the third transistor, and an output node coupled to the control node of the fourth transistor.

20. The power supply controller of claim 11, further comprising a third stage coupled to the second stage and operable to control the switching stage in response to the second feedback signal.

21. A power supply, comprising:
a supply input node;
a supply reference node;
a supply output node;
a filter having an input node and having an output node coupled to the supply output node;
a switching stage coupled between the supply input and reference nodes and operable to alternately couple the input node of the filter to the supply input node and supply reference node in response to a feedback signal;
a first feedback stage coupled to the filter input node; and
a second feedback stage coupled to the first feedback stage and operable to generate the feedback signal.

22. The power supply of claim 21 wherein the filter comprises an inductor.

23. The power supply of claim 21 wherein the filter comprises:
an inductor coupled between the filter input and output nodes; and
a capacitor coupled between the supply output node and the supply reference node.

24. The power supply of claim 21 wherein the switching stage comprises:
a first switch having a first conduction node coupled to the supply input node, a second conduction node coupled to the input node of the filter, and a control node operable to receive a control signal that is related to the feedback signal; and
a second switch having a first conduction node coupled to the second conduction node of the first switch, a second conduction node coupled to the supply reference node, and a control node coupled to the control node of the first switch.

25. The power supply of claim 21 wherein the switching stage comprises:
a first transistor having a first conduction node coupled to the supply input node, a second conduction node coupled to the input node of the filter, and a control node operable to receive a control signal that is related to the feedback signal; and
a second transistor having a first conduction node coupled to the second conduction node of the first switch, a second conduction node coupled to the supply reference node, and a control node coupled to the control node of the first switch.

26. The power supply of claim 21 wherein the switching stage comprises:
a P channel first transistor having a first source drain coupled to the supply input node, a second source drain coupled to the input node of the filter, and a gate operable to receive a control signal that is related to the feedback signal; and
an N channel second transistor having a first source drain coupled to the second source drain of the first transistor, a second source drain coupled to the supply reference node, and a gate coupled to the gate of the first transistor.

27. A system, comprising:
a power supply, comprising
a supply input node,
a supply reference node,
a supply output node,
a filter having an input node and having an output node coupled to the supply output node,
a switching stage coupled between the supply input and reference nodes and operable to alternately couple the input node of the filter to the supply input node and supply reference node in response to a feedback signal,
a first feedback stage coupled to the filter input node, and
a second feedback stage coupled to the first feedback stage and operable to generate the feedback signal; and
a load coupled to the supply output node.

28. The system of claim 27 wherein the load comprises an integrated circuit.

29. The system of claim 27 wherein at least a portion of the power supply and a portion of the load are disposed on a same integrated circuit die.

30. The system of claim 27 wherein:
at least a portion of the power supply is disposed on a first integrated circuit die; and
at least a portion of the load is disposed on a second integrated circuit die.

31. A method, comprising:
generating a first signal that is related to a current flowing through a phase of a power supply;
generating a second signal that is related to the first signal; and
controlling the current flowing through the phase in response to the second signal.

32. The method of claim 31 wherein:
the first signal comprises a first current; and
the second signal comprises a second current.

33. The method of claim 31 wherein a magnitude of the second signal is smaller than a magnitude of the first signal.

34. The method of claim 31 wherein:
the first signal comprises a first current that is smaller than the current through the phase of the power supply; and
the second signal comprises a second current that is smaller than the first current.

35. The method of claim 31 wherein generating the first signal comprises mirroring the current through the phase of the power supply to generate a first current as the first signal.

36. The method of claim 31 wherein:
generating the first signal comprises mirroring the current through the phase of the power supply to generate a first current as the first signal; and
generating the second signal comprises mirroring the first current to generate a second current as the second signal.

37. The method of claim 31 wherein:
the first signal comprises a first current;
the second signal comprises a second current;
generating the first current comprises driving a control node of a first transistor that conducts the first current with substantially a first signal level that is present on the control node of a second transistor that conducts the current flowing through the phase; and
generating the second current comprises driving a control node of a third transistor that conducts the second current with a second signal level that causes substantially a third signal level that is present on a conduction node of the second transistor to be present on a conduction node of the third transistor.

38. The method of claim 31 wherein controlling the current flowing through the phase comprises alternately switching an input node of the phase between first and second voltages in response to the second signal.
